(19) United States
(12) Patent Application Publication
(10) Pub. No.: US 2025/0296337 A1
(43) Pub. Date: Sep. 25, 2025

(54) A method of manufacturing a printhead assembly with leak-free dampers having maximum compliance

(71) Applicant: CANON KABUSHIKI KAISHA, Tokyo (JP)

(72) Inventor: Klaas VERZIJL, Well (NL)

(21) Appl. No.: 19/085,273

(22) Filed: Mar. 20, 2025

(30) Foreign Application Priority Data
Mar. 21, 2024 (EP) 24165179.3

(51) Int. Cl. B41J 2/16; B41J 2/14

(52) U.S. Cl. CPC B41J 2/16; B41J 2/14; B41J 2002/14419

(57) ABSTRACT

A printhead assembly having leak-free damper elements with optimized compliance is provided by the steps of forming a plurality of damper cavities in a support structure, providing the support structure with a damper membrane at a first pressure for substantially sealing off the damper cavities from the ambient for maintaining the first pressure inside the damper cavities, detecting a deformation of portions of the damper membrane over the substantially sealed damper cavities at a second pressure different from the first pressure, and equalizing pressures on opposite sides of the damper membrane.

### CROSS-REFERENCE TO RELATED APPLICATIONS

This application claims priority to European Patent Appl. No. 24165179.3 filed on Mar. 21, 2024, which is incorporated by reference herein in its entirety.

### BACKGROUND OF THE DISCLOSURE

### Field of the Disclosure

The disclosure relates to a method for forming a printhead assembly, a printhead assembly preferably formed by said method, and a printer including such a printhead assembly.

### Description of Background Art

A printhead assembly generally includes a large plurality droplet forming units, which are positioned in e.g. rows within a droplet forming layer assembly of the printhead assembly. To supply ink to the individual droplet forming units, a distribution layer is mounted on the droplet forming layer assembly. The distribution layer includes fluid channels to distribute fluid between the droplet forming units and the respective ink reservoirs. Since a fluid channel is in fluid connection to multiple droplet forming units, pressure waves may travel from one droplet forming unit to a neighboring droplet forming unit via a shared fluid channel. Such pressure waves may be the result of the actuation to or inside a pressure chamber of a droplet forming unit, such that a droplet is jetted from the nozzle of the respective droplet forming unit. Travelling pressure waves may interfere with the operation of a droplet forming unit. In order to at least partially absorb such pressure waves, the distribution layer may be provided with damper elements, as for example described in currently unpublished application EP21197240.1. It was found that during the manufacturing of such damper elements, it is necessary to individually check each damper element for leaks through which gas or fluid may pass to ensure the functionality of each damper element.

### SUMMARY OF THE DISCLOSURE

The present disclosure provides an improved method for manufacturing a printhead assembly that includes damper elements, specifically with an improved reliability and/or performance of the damper elements.

In accordance with the present disclosure, a method of forming a printhead assembly, a printhead assembly, and a printer are provided.

The method comprises the steps of forming at least one damper cavity in a support structure, providing the support structure with a damper membrane at a first pressure for substantially sealing off the at least one damper cavity from the ambient for maintaining the first pressure inside the at least one damper cavity, detecting a deformation of portions of the damper membrane over the substantially sealed at least one damper cavity at a second pressure different from the first pressure, and equalizing pressures on opposite sides of the damper membrane.

The at least one damper cavity is formed in the support structure. Preferably, multiple damper cavities are formed in the support structure. Each damper cavity is substantially sealed from the ambient and any fluid channels in the printhead assembly by the damper membrane at least one the side of the damper membrane, when the release opening is sealed. In this manner, the first pressure is ‘trapped’ in the at least one damper cavity. The first pressure is substantially maintained inside the at least one damper cavity when the support structure is exposed to a different pressure, for example atmospheric pressure, unless a damper cavity is unintentionally connected to the ambient via a ‘leak’. When exposed to the second pressure, a pressure difference between the inside of the at least one damper cavity and the ambient, will result a local deformation in the damper membrane over said at least one damper cavity. For example, if a damper cavity is sealed then the respective portion of the damper membrane will be deflected. If the damper cavity is leaking, i.e. unintentionally in fluid connection to the ambient, then the pressure at both sides of the damper membrane at said leaking damper cavity is substantially equal and the damper membrane will not be deflected, or vice versa. By inspecting the deflection of the damper membrane at each damper cavity, the sealing of the damper cavity can be easily checked, for example by camera or line scanner that is arranged to detect the deflection of the damper membrane. After inspection, the pressure on both sides of the damper membrane is equalized, so that the pressure inside the at least one damper cavity becomes substantially equal to that of the ambient. This may optionally be achieved by e.g. opening a release opening connected to one or more damper cavities via connection channels, such that all damper cavities connected thereto are in fluid connection to the ambient. By equalizing the pressures, the damper membrane at the damper elements assumes its substantially non-deflected state. In said state, the compliance of the damper element is greater than when pretensioned in a deflected state. Thereby, the compliance and thus the effectiveness of the damper elements is increased. Thereby the object of the present disclosure has been achieved.

More specific optional features of the disclosure are indicated in the dependent claims.

In an embodiment, the method further comprises forming at least one connection channel, so that the at least one connection channel connects the at least one damper cavity to at least one release opening on an outer surface of the printhead assembly. The connection channel connects the damper cavity to the ambient of the printhead assembly through the release opening, if the release opening is open. Preferably, the release opening is at an end or side of the connection channel, wherein the release opening is formed in the outer surface of the printhead channel. When opened, the release opening allows gas to flow between the ambient and the damper cavity via the connection channel.

In an embodiment, the method further comprises providing the support structure with the damper membrane at the first pressure for sealing off the at least one damper cavities, the at least one connection channel, and the at least one release opening from the ambient. The damper cavity and the connection channel are thereby sealed from the ambient, so the first pressure can be preserved inside the damper cavity and the connection channel. This may be achieved by sealing and/or closing the release opening at the outer surface of the printhead assembly, which allows for easily unsealing the release opening in a later step. In another embodiment, opening the release opening may comprise forming the connection channel, for example by puncturing the outer surface and/or an outer wall of the printhead assembly to connect it to the ambient. Suitable methods of puncturing include drilling, lasering, punching, etc.

In an embodiment, the step of forming the at least one damper cavity includes forming a plurality of damper cavities in the support structure such that the plurality of damper cavities is to be sealed by the damper membrane in the respective step. For each damper cavity, a deformation of a portion of the damper membrane over the substantially sealed damper cavity is to be detected in the respective step. The step of forming the at least one connection channel further includes forming a plurality of connection channels in the support structure, so that the connection channels connect the damper cavities to at least one common unsealable release opening. The step of providing the support structure includes providing the support structure with the damper membrane at the first pressure for sealing off the damper cavities, connection channels, the at least one common release opening from the ambient.

The support structure is formed with connection channel that connects multiple damper cavities to a common release point, so that the respective damper cavities are in fluid connection to the release point. Due to this connection, all respective damper cavities are at substantially the same pressure, which directly after sealing is the first pressure. By unsealing the release opening, all connected damper cavities may be easily re-pressurized to the ambient pressure, which results in the pressure on both sides of the damper membrane becoming the same or similar.

In an embodiment, the step of forming the damper cavities includes forming the damper cavities, the connection channels, and the release opening so as to be sealed from the ambient. The damper cavities, the connection channels, and the release opening are connected to one another, such that they form an inner volume in the support structure. This inner volume is substantially sealed or closed off from the ambient atmosphere surrounding the support structure. Gas from the ambient is substantially prevented from entering the inner volume. In consequence, the pressure in the inner volume at the moment of sealing the inner volume is maintained, unless the support structure was formed with an unintentional leak. Similarly, the inner volume is sealed off from any fluid channels extending through the support structure. The damper membrane is preferably sealed on one side by the damper membrane and on an opposite side by a capping layer. It will be appreciated that therein substantially sealed is intended to reflect a design wherein the inner volume is entirely isolated from the ambient, except when unintentional leaks have occurred during the manufacturing process.

In an embodiment, the step of equalizing includes opening the at least one common unsealable release opening. By opening the previously sealed release opening, the damper cavities are brought into connection with the ambient. The inner volume thereby assumes the same pressure as the ambient, which was preferably a different pressure than the first pressure under which the support structure was sealed. By opening a release opening, all connected damper cavities are re-pressurized equal to the ambient pressure, thereby bringing the damper membrane at the damper elements in a state of maximum compliance. It will be appreciated that, per support structure, multiple release points may be provided, which are each in fluid connection to one or more damper cavities of the support structure.

In an embodiment, the first pressure is a negative pressure as compared to the second pressure. Preferably the second pressure is at or near atmospheric pressure. The second pressure is preferably the pressure of the surrounding of the printhead assembly during use, which is generally atmospheric pressure. When the assembly is formed by MEMS manufacturing the first pressure is generally a negative and/or vacuum pressure.

In an embodiment, the damper cavities, the connection channels, and the release opening are positioned in the same plane, preferably with the same layer. The damper cavities, the connection channels, and the release opening forming the inner volume are preferably formed within a single, planar sheet. The sheet is for example a silicon wafer wherein the damper cavities, the connection channels, and the release opening are etched by photo-lithographic techniques.

In an embodiment, the method further comprises the step of forming the support structure having a first layer adhered to one side of a membrane layer and a second layer adhered to an opposite side of the membrane layer, which membrane layer locally forms the damper membrane over the at least one damper cavity or plurality of damper cavities, and wherein the at least one damper cavity or plurality of damper cavities is formed in the second layer. In another embodiment, the method further comprises the step of attaching a capping layer on the second layer, which includes the one or more damper cavities, connection channels, and the release opening, such that the one or more damper cavities on opposite sides in a stacking direction of the layers are sealed by respectively the capping layer and the membrane layer. One layer is a damper forming layer, which defines the inner volume. The other layer is a fluid channel layer for flowing fluid to and/or from the droplet forming units. The damper membrane is provided with openings for the fluid channels, so that fluid may pass through the membrane layer. Such openings may be provided in the form of a filter by locally providing multiple small openings in the membrane layer. Over the one or more damper cavities, the damper membrane remains unpunctured, so that it locally seals the one or more damper cavities.

In an embodiment, the step of equalizing further comprises allowing the damper membranes over the one or more damper cavities to change their curvature or bending. The pressure difference between the inside of the inner volume and the surrounding atmosphere is minimized. This may for example be achieved by opening the release opening to the atmosphere or by matching the first pressure inside the inner volume to the ambient pressure during operation of the printhead assembly (wherein the second pressure during inspection is different to deflect the damper membrane). Consequently, the damper membrane at the one or more damper cavities returns from a deflected state and/or shape to a substantially undeflected and/or straight form.

In an embodiment, the step of detecting includes determining a measure of curvature or bending of the damper membranes over the one or more damper cavities. Preferably, for each damper cavity a parameter proportional to the deflection and/or curvature of the damper membrane at said damper cavity is measured, for example by optical reflection measurements or 3D scanning. As discussed above, the deflection and/or curvature of a portion of the damper membrane at a ‘leaking’ damper cavity is different than that of an entirely sealed damper cavity. This allows for quick and easy determination of faulty damper elements. In another embodiment, the method further includes determining a potential leak when locally a damper membrane over a damper cavity has been determined to be substantially straight in a direction perpendicular to a stacking direction of layers of the printhead assembly. In an embodiment, the inspection of the one or more damper elements is performed at atmospheric pressure, so that in case of a leak, the pressure inside a leaking damper cavity will match that of the ambient. In consequence, the damper membrane at a leaking damper element will return to its straight state. This in contrast to non-leaking damper elements, where the damper membrane will be locally curved.

The disclosure further relates to a printhead assembly including a plurality of droplet jetting units mounted on a support structure, which support structure includes a plurality of fluid channels for supplying fluid to the droplet jetting units, at least one, and preferably a plurality of, damper cavities and at least one, and preferably a plurality of, connection channels formed in the support structure, so that the one or more connection channels connect the one or more damper cavities to at least one common unsealable release opening.

The disclosure further relates to a printhead assembly comprising:
a plurality of droplet jetting units mounted on a support structure, wherein the support structure includes a plurality of fluid channels configured to supply fluid to the droplet jetting units;
at least one damper cavity and at least one connection channel formed in the support structure, wherein the at least one connection channel connects the at least one damper cavity to at least one common unsealable release opening, wherein the release opening is arranged to substantially connect the at least one damper cavity to the ambient when the release opening is unsealed;
a membrane provided in and/or on the support structure, so that the at least one damper cavity, the at least one connection channel, and the at least one common release opening are adhered to one side of the membrane, which membrane locally forms a damper membrane over the at least one damper cavity.

The at least one release opening is arranged to provide the substantially only connection of the one or more damper cavities to the ambient; a damper membrane provided in and/or on the support structure, so that the one or more damper cavities, connection channels, and the at least one common release opening are sealed off from the fluid channels. Preferably, the at least one damper cavity, the at least one connection channel, and the at least one common release opening are positioned together in one flat plane. The at least one damper cavity, the at least one connection channel, and the at least one common release opening are preferably formed from a flat plate-shape material in the form of recesses therein.

The support structure is formed as discussed above. The one or more damper cavities, connection channels, and the release point are in fluid connection to one another inside the support structure. The inner volume is substantially entirely sealed from the ambient by sealing or closing the release point. The inner volume is also substantially entirely separated from the fluid channels, so no gas or fluid can pass between the fluid channels and the inner volume. The sealing may however be comprised by unintentional leaks that are formed during the manufacturing process, so that a fluid connection exists between the inner volume and the ambient or the fluid channels. The presence of such leaks can be easily detected by applying the above-described method, which utilizes the sealing of the inner volume. Additionally, after detection, the inner volume can re-pressurized by opening the release point. Thereby, the damper membrane at the damper cavities returns to its substantially undeflected state, which offers maximum compliance. Thus, a printhead assembly with leak-free damper cavities and optimal compliance of the damper elements can be provided.

In an embodiment, the support structure includes a first layer and a second layer adhered to opposite sides of a membrane layer, which membrane layer locally forms the damper membrane over the one or more damper cavities. The one or more damper cavities, connection channels, the at least one release point are preferably formed in the same planar layer, which is preferably the first layer. The one or more connection channels preferably extend perpendicular to a longitudinal direction of the one or more damper cavities. Said planar, first layer is preferably opposite to a second layer which faces the droplet jetting units. The inner volume is thus on an opposite side of the damper membrane as the droplet forming units. The membrane layer is preferably formed of an elastic film.

In an embodiment, the second layer includes fluid channels in fluid connection to the droplet jetting units and positioned on an opposite side of the damper membrane with respect to the one or more damper cavities. The fluid channels extend parallel to the damper membrane along the respective one or more damper cavities, so that during use opposite to the at least one damper cavity the damper membrane is contact with fluid. It will be appreciated that the first layer may include fluid channels as well to transport fluid to the respective fluid channels in the second layer on the opposite side of the damper membrane.

In an embodiment, a plurality of damper cavities and connection channels are formed in the support structure, and the damper cavities are formed as longitudinal trenches separated by trenches forming the fluid channels in the first layer, which are in fluid connection to openings in the damper membrane and via those are in fluid connection to fluid channels in the second layer.

The present disclosure further relates to a printer including the printhead assembly as described above. The printer is preferably an inkjet printer.

Further scope of applicability of the present disclosure will become apparent from the detailed description given hereinafter. However, it should be understood that the detailed description and specific examples, while indicating preferred embodiments of the present disclosure, are given by way of illustration only, since various changes and modifications within the spirit and scope of the present disclosure will become apparent to those skilled in the art from this detailed description.

### BRIEF DESCRIPTION OF THE DRAWINGS

The present disclosure will become more fully understood from the detailed description given herein below and the accompanying drawings that are given by way of illustration only, and thus are not limitative of the present disclosure, and wherein:

FIG. 1 is a schematic, cross-sectional view of a printhead assembly according to the present disclosure;

FIG. 2 is a schematic, perspective view of a printhead assembly in FIG. 1 without a capping layer;

FIGS. 3 to 10 are schematic, cross-sectional views illustrating different steps of forming a support structure for the printhead assembly in FIG. 1;

FIG. 11 is a schematic, cross-sectional view illustrating the step of inspecting the damper elements of the support structure formed via the method in FIGS. 3 to 10;

FIG. 12 is a schematic, perspective view of a printhead assembly in FIG. 1 with the capping layer wherein the releasing opening is sealed;

FIG. 13 is a schematic, perspective view of a printhead assembly in FIG. 1 with the capping layer wherein the releasing opening is open.

### DETAILED DESCRIPTION OF THE EMBODIMENTS

The present disclosure will now be described with reference to the accompanying drawings, wherein the same reference numerals have been used to identify the same or similar elements throughout the several views.

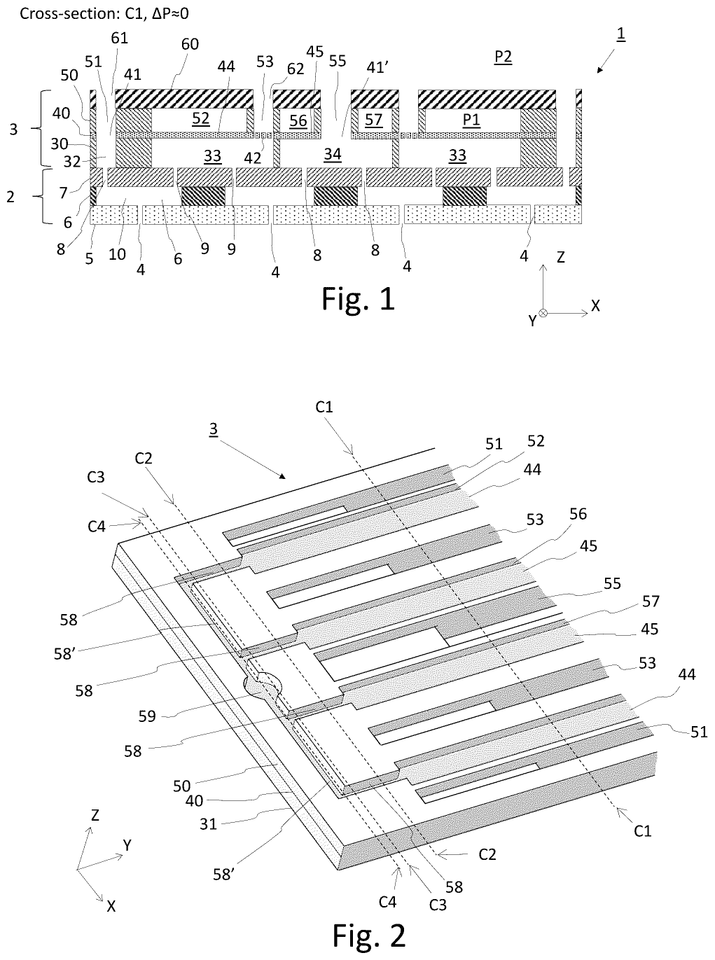

FIG. 1 shows a cross-section of a printhead assembly 1 through the XZ plane at the cross-section C1 indicated in FIG. 2. The printhead assembly 1 includes two layers 2, 3. The bottom layer is a droplet jetting layer assembly 2, which includes a plurality of droplet jetting units, each of which includes a nozzle 4 formed in a nozzle plate 5. In FIG. 1, four droplet jetting units with four corresponding nozzles 4 are positioned besides each other in the first direction X. It is noted that the droplet jetting units are further positioned in rows in the second direction Y. The number of droplet jetting units in a single row in the second direction Y is relatively high, for example several hundreds of units per inch, corresponding to the DPI of the respective printhead assembly 1.

The nozzle plate 5 is mounted on a pressure chamber forming plate 6. The pressure chamber forming plate 6 defines a plurality of pressure chambers 10 separated from one another by wall elements. The pressure chambers 10 are in fluid connection to their nozzles 4. The pressure chamber forming layer 6 is further mounted on an actuator layer 7, so that the pressure chambers 10 are in between the actuator layer 7 and the nozzle plate 5 in the stacking direction Z of the layers. The actuator layer 7 includes, for each pressure chamber 10, an actuator (not shown) arranged to generate a pressure pulse in fluid inside the pressure chamber 10, so that a droplet of said fluid is jetted from the nozzle 4. The actuator may be a piezo-electric actuator provided on a flexible membrane to momentarily adjust the volume of the pressure chamber or a thermal actuator arranged to generate and manipulate a gas bubble in said pressure chamber 10 to change the pressure. The actuator layer 7 includes inlet and outlet restrictors 8, 9 for respectively flowing fluid into and out of the pressure chamber 10, so that fluid in the pressure chamber 10 may be kept constantly flowing through the pressure chamber 10, even when the actuator is not applied for jetting droplets from the nozzle 4. Fluid in the pressure chamber 10 may be circulated through outside the pressure chamber 10, and may be further circulated through outside the printhead assembly 1.

The combined layers 5-7 form the droplet jetting layer 2. The droplet jetting layer 2 is mounted on the filter-damper layer assembly 3. The filter-damper layer assembly 3 forms a support structure for the droplet jetting layer 2. A plurality of fluid channels are provided in the filter-damper layer assembly 3 to supply and respectively remove fluid from the inlet and outlet restrictors 8, 9 of the droplet jetting units. The filter-damper layer assembly 3 is formed of four layers: a first layer 30, a second layer 50 provided on opposite sides of a membrane layer 40, and a capping layer 60. The first layer 30 defines a number of channel segments 32, 33, 34, which are positioned over the inlet or outlet restrictors 8, 9 and are in fluid connection therewith. The first layer 30 has separate channel segments 32, 33, 34, for the inflow and the outflow of fluid. The inflow and outflow channel segments 32, 33, 34 are separated from one another by wall segments. At least a portion of the channel segments 32, 33, 34 in the first layer 30 are delimited in the stacking direction Z by the membrane layer 40. The membrane layer 40 is formed of a relatively thin damper membrane. Suitable materials for forming the membrane layer 40 may be foils made of plastic or metal (e.g. titanium, silver, gold, etc.). Preferably, the membrane layer 40 is formed of a polymer material, applicable in MEMS processing. For example, a polyimide foil may be applied to form the membrane layer 40 in FIG. 1. Other suitable materials may be SU-8, Parylene, polydimethylsiloxane (PDMS), liquid crystal polymers (LCPs), cyclic olefin polymers (COPs), polymethyl methacrylate (PMMA or plexiglass), polycarbonate (PC), and polystyrene (PS), etc. The membrane layer 40 has been processed at the locations of the channel segments 32, 33, 34 in the first layer 30 to include openings 41, 42 to provide a fluid connection. The openings 41, 42 are formed by creating openings in the damper layer 40: the inflow opening 42 is formed as a filter by providing multiple small openings in the damper layer 40 at the respective location, while the outflow opening 41 is formed as a uniform through-hole. The second layer 50 includes a plurality of channel segments 51, 53, 55 in fluid connection to the channel segments 32, 33, 34 in the first layer 30. The channel segments 51, 53, 55 in the second layer 50 are positioned over the channel segments 32, 33, 34 in the first layer 30. The second layer 50 further includes damper cavities 52, 56, 57 in between the channel segments 51, 53, 55. The damper cavities 52, 56, 57 are sealed off on a side facing the first layer 30 by the damper membrane formed by the membrane layer 40. The damper cavities 52, 56, 57 extend over at portion of the respective channel segments 33, 34 in the first layer 30. The damper cavities 52, 56, 57 are further positioned over the respective inlet and outlet restrictors 8, 9 with the exception of the outer outlet restrictors 8. Thus, a portion of the damper membrane extends over the respective inlet and outlet restrictors 8, 9. The damper membrane at the damper cavities 52, 56, 57 is flexible, so that it is able to deform into and/or away from the damper cavities 52, 56, 57. Thereby, a damper element 44 is formed facing the respective inlet restrictors 9 and a further damper element 45 is formed facing the respective outlet restrictor 8. A pressure pulse or wave leaving the respective inlet and outlet restrictors 8, 9 can be adsorbed by the damper elements 44, 45 to prevent the pressure pulse or wave from negatively affecting the droplet jetting from an adjacent pressure chamber 10. A capping layer 60 is provided to seal off the damper cavities 52,56, 57. The capping layer 60 includes channel segments 61, 62 to form the inflow and outflow channel by fluid connection to the respective other channel segments in the other layers 30, 40, 50. In FIG. 1, the damper cavities 52, 56, 57 are at a first pressure P1, which is similar to the ambient pressure P2 of the surroundings of the printhead assembly 1 during use. Thus, in FIG. 1, the pressure difference ΔP between inside the damper cavities 52, 56, 57 and the ambient is substantially zero:

ΔP=P2−P1≈0

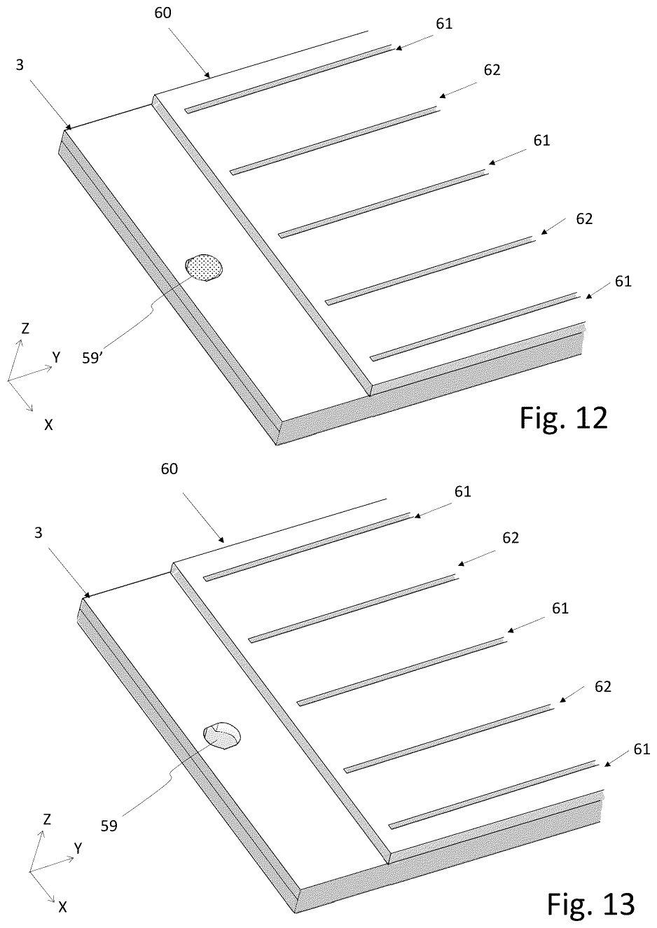

FIG. 2 illustrates the filter-damper layer assembly 3 without the capping layer 60. The damper cavities 52, 56, 57 extend as uniform trenches in the second direction Y. On one of their ends in the second direction Y, the damper cavities 52, 56, 57 are connected to at least one common release opening 59 via connection channels 58. While a single release opening 59 is illustrated in FIG. 2, it will be appreciated that multiple release openings 59 may be applied as well, especially in case of a wider and/or more complex structure of cavities and channels. The connection channels 58 are formed in the second layer 50. The connection channels 58 are connected on one end to an end of a respective damper cavities 52, 56, 57 and on another end to the release opening 59. The connection channels 58 are sealed on the bottom side by the damper membrane. With the capping layer 60 in place, the damper cavities 52, 56, 57 are entirely sealed with the only exception being their connection to the release opening 59 via the connection channels 58. Consequently, the damper cavities 52, 56, 57 will at all times be at the same pressure as the release opening 59. The release opening 59 may be sealed off from the ambient, for example by sealing the open area of the release opening 59 in the capping layer 60. FIG. 12 illustrates a sealed release opening 59 that is covered by a seal 59′. The release opening 59 includes an open area in an outer surface in contact with the ambient during use. For example, in FIG. 12, the release opening 59 is positioned at an outer surface of the second layer 50, though it will be appreciated that the release opening 59 may be positioned at any outer surface of the printhead assembly 1. The release opening 59 is sealed by covering the open area with the seal 59′, so that no gas can pass into the release opening 59 from the ambient. The seal 59′ is formed of an impermeable material, specifically one impermeable to air. The seal 59 may be a membrane, formed e.g. of the above-mentioned materials that can be applied for the membrane layer 40. The seal 59′ may alternatively be formed of an adhesive or may be in the form of a re-usable sealing member, such as a plug or stop.

Preferably, the seal 59′ at the release point is easily unsealable, for example by being formed as a thin sealing film that can be punctured or at least partially removed. FIG. 13 illustrates an unsealed release opening 59, wherein the seal 59′ has been entirely removed from the release opening 59. The seal 59′ may also be partially removed, e.g. by scraping, pulling, lasering, melting, etc. Alternatively, the seal 59′ may be punctured using a needle-like device to form an opening through the seal 59′, so that the release opening 59 is connected to the ambient. Thereby, the damper cavities 52, 56, 57 and the connection channels 58 are sealed off or isolated from the ambient conditions outside of the filter-damper layer assembly 3. By opening the sealing opening 59, a connection to the ambient is established to the damper cavities 52, 56, 57 and the connection channels 58.

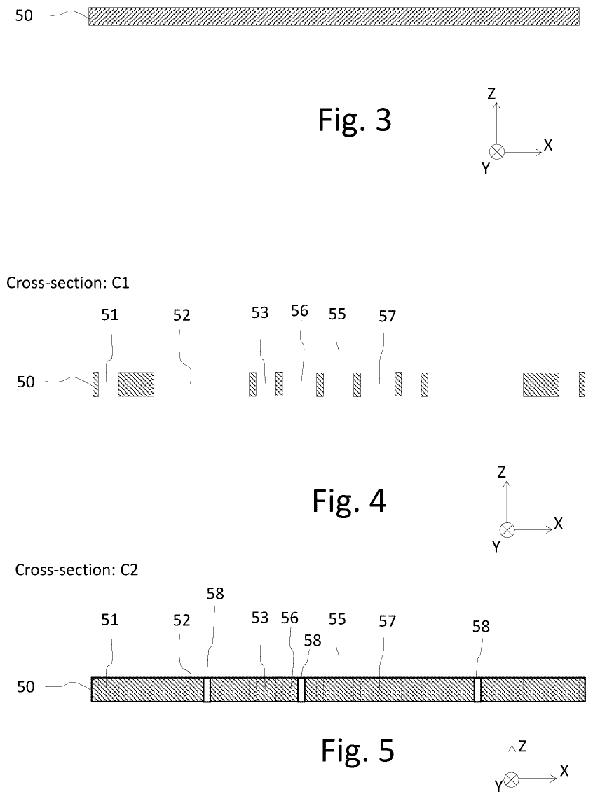

FIG. 3 illustrates a first step of forming a printhead assembly 1. A damper forming substrate for forming the second layer 50, which will act as a damper forming layer, is provided in the form of a sheet or plate, which is planar in the first and second directions X, Y. The damper forming substrate 50 is preferably formed of silicon, which may be etched by known lithographic techniques, milled, cut, or otherwise processed, so that the channel segments 51, 53, 55 and the damper cavities 52, 56, 57 are formed, as shown in FIG. 4.

FIG. 4 illustrates a cross-section of the damper forming layer 50 at the cross-section C1, as indicated in FIG. 2. The damper cavities 52, 56, 57 are etched as longitudinal trenches extending in the second direction Y over nearly the width of the damper forming substrate 50. The damper cavities 52, 56, 57 are separated from each by at least one channel segment 51, 53, 55, which also extend across substantially the full width in the second direction Y. The damper cavities 52, 56, 57 have a constant cross-section along the second direction Y. The channel segments 51, 53, 55 preferably also have respective constant cross-sections (which cross-sections may differ per channel segment 51, 53, 55), but may also be provided with an alternating pattern of channels and barriers along the second direction Y. Each damper cavity 52, 56, 57 is separated from its respective neighboring channel segments 51, 53, 55 by a wall element that extends continuously in the second direction Y. In the first direction X, there is an alternating pattern of damper cavities 52, 56, 57 and channel segments 51, 53, 55 with a wall element positioned in between a pair of a damper cavity 52, 56, 57 and a channel segments 51, 53, 55. The damper cavities 52, 56, 57 and channel segments 51, 53, 55 are formed by removing material from the damper forming substrate 50. In FIG. 4, the damper forming substrate 50 is etched such that the damper cavities 52, 56, 57 and channel segments 51, 53, 55 extend entirely through the damper forming substrate 50 in the third direction Z. The wall elements are formed by unetched portions of the damper forming substrate 50.

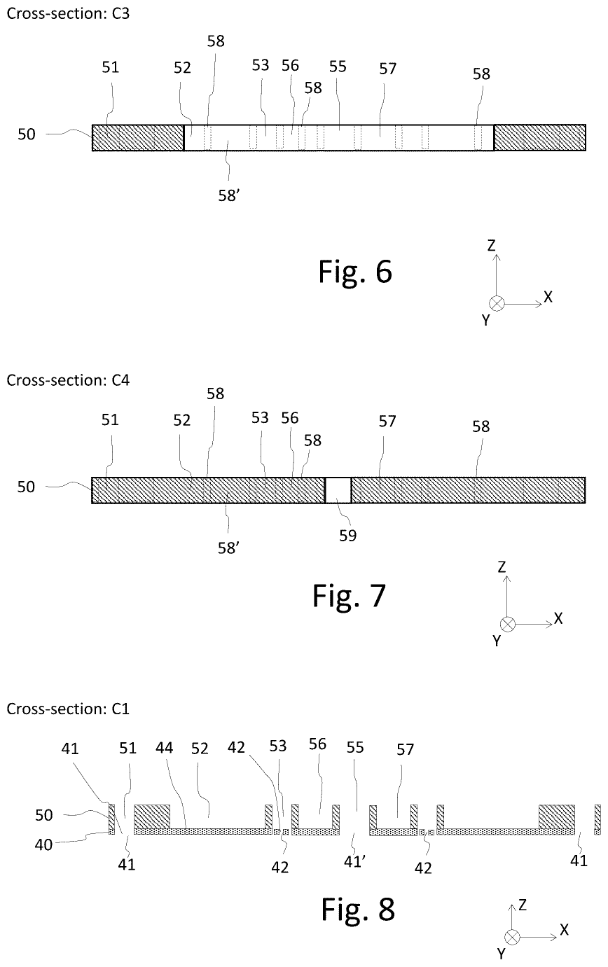

In the above step, the connection channels 58 are also formed, which are illustrated in FIGS. 5 and 6. FIGS. 5 and 6 correspond to cross-sections taken at the cross-section points C2 and C3 indicated in FIG. 2. FIG. 5 illustrates the connection channels 58 being formed as a narrow extension of the damper cavities 52, 56, 57 in the second direction Y. The connection channels 58 are formed in the damper forming layer 50. The connection channels 58 are positioned at or near the edge of the damper forming layer 50 in the second direction Y. This allows for a compact positioning of the droplet forming units 10, so the nozzles 4 can be positioned relatively close to one another. The connection channels 58 can be positioned on one side of the printhead assembly 1, allowing them to be easily applied to existing printhead assemblies without requiring significant modifications. Every damper cavity 52, 56, 57 includes a connection channel 58, which is positioned at and connected to an end of said damper cavity 52, 56, 57 in the second direction Y. It is noted that after the step shown in FIG. 10, every damper cavity 52, 56, 57 is entirely sealed from the ambient with the sole exception of the connection channel 58.

FIG. 6 illustrates a further connection channel 58′ that extends in the first direction X to connect the connection channels 58 in FIG. 5 to one another. The further connection channel 58′ is formed in the damper forming layer 50 along with the damper cavities 52, 56, 57. The further connection channel 58′ extends perpendicular to a longitudinal direction Y of the damper cavities 52, 56, 57. The combined connection channels 58, 58′ establish a fluid connection between preferably all damper cavities 52, 56, 57. The connection channels 58, 58′ further connect to a common release opening 59, also formed in the damper forming layer 50, as illustrated in FIG. 7 (which corresponds to cross-section C4 in FIG. 2). The release opening 59 is formed as a widened portion of the further connection channel 58′. A wider release opening 59 allows the channel connection structure to be kept relatively compact, while making it relatively easy to open the release opening 59, e.g. by puncturing it. In another embodiment, the release opening 59 need not be widened and has a similar cross-section as the further connection channel 58′ or be formed as a portion thereof. After providing the capping layer 60 as in FIG. 10, the whole of the damper cavities 52, 56, 57 and the connection channels 58, 58′ is effectively sealed from the ambient with the exception of the release opening 59. The capping layer 60 preferably has an opening overlapping the release opening 59, so that the release opening 59 can be accessed for unsealing the release opening 59. The connection channels 58, 58′ are arranged such that gas from the ambient can only flow to the damper cavities 52, 56, 57 via the release opening 59. It will be appreciated that the connection channels 58, 58′ may be configured differently, for example as channels in the second direction Y positioned between neighboring damper cavities 52, 56, 57. The release opening 59 may, in another embodiment, be formed differently as well, for example, as mentioned above, as a portion or section of a connection channel 58, 58′ and/or a damper cavity 52, 56, 57 by forming an opening in the capping 60 at said portion or section.

FIG. 8 illustrates the step of mounting a flexible membrane film on the etched damper forming layer to form the membrane layer 40. The flexible membrane film may be attached using an adhesive, heat sealing, or other suitable methods. The membrane layer 40 has been locally processed at the channel segments 51, 53, 55 to form openings for letting fluid pass through. At the inlet channel segments 53, inflow openings 42 are provided. The inflow openings 42 are defined by the membrane layer 40 locally having a plurality of small openings, which acts as a filter 42. The filter 42 prevents gas bubbles or dirt particles from reaching the droplet forming units. At the outlet segments 51, 55, the membrane layer 40 has been processed to include a single large openings 41. The left and right outflow openings 41 overlap respectively with an outlet channel segment 51, when viewed in the third direction Z. The central outflow opening 41′ overlaps respectively with the central outlet channel segment 55. Each filter 42 (which defines an inflow opening) overlaps respectively with an inlet channel segment 53. Over the damper cavities 52, 55, 57, the membrane layer 40 is sealed so that it contains no openings. On the side of the membrane layer 40, the membrane layer 40 seals off the damper cavities 52, 55, 57, so that no fluid or gas can pass into the damper cavities 52, 55, 57.

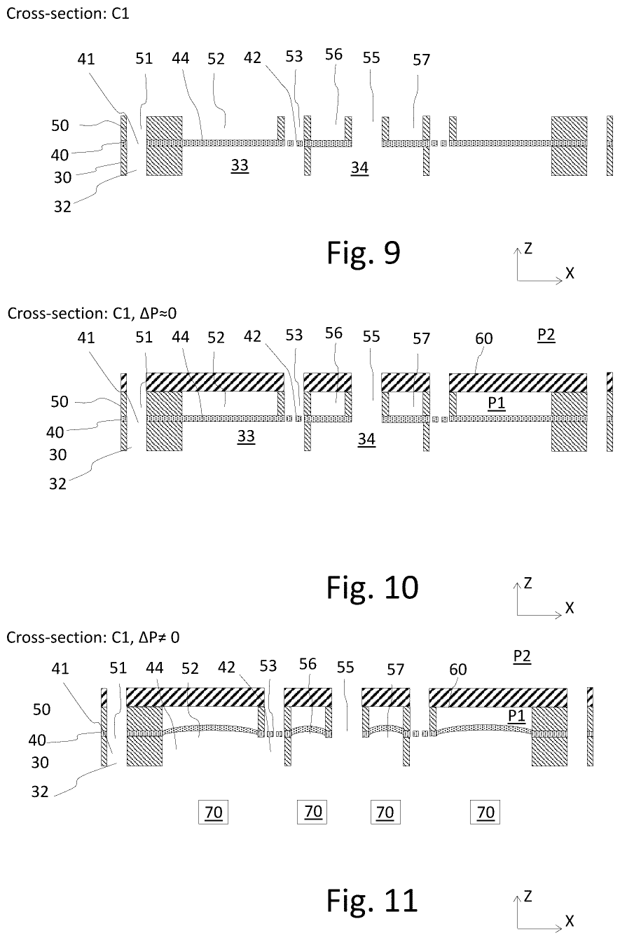

FIG. 9 illustrates the step of attaching the first layer 30, which acts as a distribution layer, on the membrane layer 40 opposite the damper forming layer 50. The first layer 30 is formed of similar substrate and processed to include the inflow channel segments 33, and/or the outflow channel segments 32, 34. The inflow and out flow channel segments 33, 34 are positioned to overlap with the corresponding damper cavities 52, 56, 57, so at the damper cavities 52, 56, 57 the flexible membrane film is locally free. This allows the flexible membrane film there to deform into and out of the damper cavities 52, 56, 57. Thereby, damper elements 44 are formed, which are arranged to at least partially absorb a pressure wave traveling through the inflow and out flow channel segments 33, 34. The membrane film is preferably elastic, so that it returns to its undeflected state in absence of pressure waves or pressure differences.

FIG. 10 illustrates the step of attaching the capping layer 60 onto the second layer 50. The capping layer 60 is provided with openings corresponding to and overlapping with the inflow and outflow channel segments 32, 33, 34. The capping layer 60 further seals the damper cavities 52, 56, 57 and the connection channels 58, 58′ so no fluid of gas can enter these from the side of the capping layer 60. Additionally, the release opening 59 is sealed off by a corresponding section of the capping layer 60 as well. It is noted that at the release opening 59, the capping layer 60 may be provided with a releasable seal over the release opening 59, so that the release opening 59 may be easily exposed to the ambient by opening or removing this seal. However, in the step in FIG. 10, the internal channel structure connected to the damper cavities 52, 56, 57 is sealed off from the ambient. The sealing and unsealing of the release opening 59 is discussed in further detail with respect to FIGS. 12 and 13.

At least the sealing step in FIG. 10 is performed at a different ambient pressure than the operational pressure of the printhead assembly 1, so that this pressure is maintained inside the damper cavities 52, 56, 57 as the pressure P1. Generally, the operational ambient pressure for a printhead assembly is atmospheric pressure. In the example herein, the filter-damper layer assembly 3 is formed using lithographic techniques, which are performed at vacuum or negative pressures as compared to the atmospheric pressure. In consequence, at the moment of sealing off the damper cavities 52, 56, 57 in step 10, the pressure P1 inside the damper cavities 52, 56, 57 is negative as compared to atmospheric pressure. Due to the sealing, this pressure is maintained inside the damper cavities 52, 56, 57 when the filter-damper layer assembly 3 is exposed to the atmospheric pressure by removing it from its manufacturing device or plant.

As a consequence of the inner negative pressure inside the damper cavities 52, 56, 57, the flexible damper membrane film at the damper elements 44, 45 bends inwards, when the filter-damper layer assembly 3 is exposed to atmospheric pressure. The curvature of the film of the damper element 44, 45 is thus a measure of the air tightness of the damper cavities 52, 56, 57. Should the printhead assembly 1 contain a leak to the ambient, the negative pressure in the respective damper cavity 52, 56, 57 cannot be maintained. In consequence, the film of a leaking damper element 44, 45 will not be bent as in FIG. 11. Thus, leaking and air-tight damper cavities 52, 56, 57 can be distinguished from one another by the local curvature of the damper membrane. This manner of inspection is performed in FIG. 11, wherein the curvature of the damper membrane for all damper cavities 52, 56, 57 is inspected using a suitable inspection tool 70, for example a camera or line scanner. In case, a damper membrane at a damper cavity 52, 56, 57 is locally not curved, then the damper cavity 52, 56, 57 is connected to the ambient due to a leak. The respective printhead assembly 1 should not be used in its current state, as the leak may be the result of an undesired fluid connection to the fluid channel structure, which during use would result in the leakage of ink. In case all membrane cavities 52, 56, 57 show a curved damper membrane, air tightness is assumed.

In a subsequent step, the release opening 59 is opened to the ambient, so that the damper cavities 52, 56, 57 via the connection channels 58, 58′ are allowed to assume the ambient pressure. Thereby, at the damper cavities 52, 56, 57 the pressure on both sides of the damper membrane is equalized, which returns the damper membrane to its neutral state, as in FIG. 1. In the neutral state, the compliance of the damper membrane is maximized, allowing for optimum deflection in both directions. Thus, a leak-free printhead assembly 1 with damper elements 44, 45 with a maximized compliance is achieved.

FIG. 12 shows the printhead assembly in FIG. 2 but provided with the capping layer 60. As discussed for FIG. 10, the capping layer 60 covers the second layer 50. The channel segments 61, 62 in FIG. 12 are illustrated as straight channels, which alternate in the direction X. It will be appreciated that the capping layer 60 may also be provided with a different channel structure, for example wherein the inflow for each respective fluid channel 51, 53, 55 is formed by multiple, individual openings spaced apart in the direction Y. In FIG. 12, the release opening 59 has been unsealed, as discussed above, to connect the damper cavities 52, 56, 57 to the ambient.

Although specific embodiments of the disclosure are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

The present disclosure being thus described, it will be obvious that the same may be varied in many ways. Such variations are not to be regarded as a departure from the spirit and scope of the present disclosure, and all such modifications as would be obvious to one skilled in the art are intended to be included within the scope of the following claims.

1. A method for forming a printhead assembly, comprising:
forming at least one damper cavity in a support structure;
providing the support structure with a damper membrane at a first pressure for substantially sealing off the at least one damper cavity from the ambient for maintaining the first pressure inside the at least one damper cavity;
detecting a deformation of a portion of the damper membrane over the substantially sealed at least one damper cavity at a second pressure different from the first pressure; and
equalizing pressures on opposite sides of the damper membrane.

2. The method according to claim 1, further comprising forming at least one connection channel, so that the at least one connection channel connects the at least one damper cavity to at least one release opening on an outer surface of the printhead assembly.

3. The method according to claim 2, further comprising providing the support structure with the damper membrane at the first pressure for sealing off the at least one damper cavities, the at least one connection channel, and the at least one release opening from the ambient.

4. The method according to claim 3, wherein the step of forming the at least one damper cavity comprises forming a plurality of damper cavities in the support structure such that the plurality of damper cavities is to be sealed by the damper membrane, wherein for each damper cavity, a deformation of a portion of the damper membrane over the substantially sealed damper cavity is detected in the detecting step,
wherein the step of forming the at least one connection channel comprises forming a plurality of connection channels in the support structure, so that the connection channels connect the damper cavities to at least one common unsealable release opening, and
wherein the step of providing the support structure comprises providing the support structure with the damper membrane at the first pressure for sealing off the damper cavities, connection channels, and the at least one common release opening from the ambient.

5. The method according to claim 4, wherein the step of forming the damper cavities comprises forming the damper cavities, the connection channels, and the release opening so as to be sealed from the ambient.

6. The method according to claim 4, wherein the step of equalizing comprises opening the at least one common unsealable release opening.

7. The method according to claim 4, wherein the first pressure is a negative pressure as compared to the second pressure, and wherein the second pressure is at or near atmospheric pressure.

8. The method according to claim 1, further comprising forming the support structure having a first layer adhered to one side of a membrane layer and a second layer adhered to an opposite side of the membrane layer, wherein the membrane layer locally forms the damper membrane over the at least one the damper cavity, and wherein the at least one damper cavity is formed in the second layer.

9. The method according to claim 8, further comprising attaching a capping layer on the second layer, such that the at least one damper cavity on opposite sides in a stacking direction of the layers are sealed by respectively the capping layer and the membrane layer.

10. A printhead assembly comprising:
a plurality of droplet jetting units mounted on a support structure, wherein the support structure includes a plurality of fluid channels configured to supply fluid to the droplet jetting units;
at least one damper cavity and at least one connection channel formed in the support structure, wherein the at least one connection channel connects the at least one damper cavity to at least one common unsealable release opening, wherein the release opening is arranged to substantially connect the at least one damper cavity to the ambient when the release opening is unsealed;
a membrane provided in and/or on the support structure, so that the at least one damper cavity, the at least one connection channel, and the at least one common release opening are adhered to one side of the membrane, which membrane locally forms a damper membrane over the at least one damper cavity.

11. The printhead assembly according to claim 10, wherein the at least one damper cavity, the at least one connection channel, and the at least one common release opening are positioned together in one flat plane.

12. The printhead assembly according to claim 10, wherein the at least one damper cavity, the at least one connection channel, and the at least one common release opening are formed in a first layer opposite to a second layer that faces the droplet jetting units.

13. The printhead assembly according to claim 12, wherein the second layer comprises fluid channels in fluid connection to the droplet jetting units and positioned on an opposite side of the damper membrane with respect to the at least one damper cavity.

14. The printhead assembly according to claim 12, wherein a plurality of damper cavities and connection channels are formed in the support structure, and wherein the damper cavities are formed as longitudinal trenches separated by trenches forming the fluid channels in the first layer and are in fluid connection to openings in the damper membrane and are in fluid connection to fluid channels in the second layer via those openings.

15. A printer comprising the printhead assembly according to claim 10.
